(19) United States
(12) Patent Application Publication
(10) Pub. No.: US 2019/0258994 A1
(43) Pub. Date: Aug. 22, 2019

(54) SYSTEMS AND METHODS FOR SHIPPING MANAGEMENT

(71) Applicant: David Crane, Montrose, CO (US)

(72) Inventor: David Crane, Montrose, CO (US)

(21) Appl. No.: 16/386,109

(22) Filed: Apr. 16, 2019

Related U.S. Application Data
(63) Continuation of application No. 15/172,696, filed on Jun. 3, 2016.
(60) Provisional application No. 62/170,609, filed on Jun. 3, 2015.
(60) Provisional application No. 62/222,496, filed on Sep. 23, 2015.

(51) Int. Cl. G06Q 10/08; G06Q 20/18

(52) U.S. Cl. CPC G06Q 10/0836; G06Q 20/18

(57) ABSTRACT

A system for shipping management. The system includes a shipping database receiving shipping information from a user regarding a physical package and an access point. The access point connected to the shipping database and receiving the shipping information from the shipping database. The access point also measures at least one attribute of the physical package and sends the measured attribute to the shipping database to be added to the shipping information. The access point includes a scale, where the scale measures the weight of the physical package and a size sensor, the size sensor measures at least one dimension of the physical package. The system also includes a package drop. The package drop receives the shipping information from the database, accept the physical package from the user and store the physical package until pickup by a shipping provider. The system additionally includes a communication module. The communication module electronically communicates with a user's electronic system.

### CROSS-REFERENCE TO RELATED APPLICATIONS

This application is a continuation of, and claims the benefit of and priority to, U.S. Non-Provisional patent application Ser. No. 15/172,696 filed on Jun. 3, 2016, which application is incorporated herein by reference in its entirety

U.S. Non-Provisional patent application Ser. No. 15/172,696 claims the benefit of and priority to U.S. Provisional Patent Application Ser. No. 62/170,609 filed on Jun. 3, 2015, which application is incorporated herein by reference in its entirety

U.S. Non-Provisional patent application Ser. No. 15/172,696 claims the benefit of and priority to U.S. Provisional Patent Application Ser. No. 62/222,496 filed on Sep. 23, 2015, which application is incorporated herein by reference in its entirety.

### BACKGROUND OF THE INVENTION

Package shipping intake or enrollment at retail locations is typically a linear process with ship to address look up and input/application, ship from address look up and input/application and payment happening one at a time. While effective, it is a slow system and frequently results in error due to omission, transcription, sloppiness in as handwriting and so forth.

Accordingly a faster system to apply the ship to and from addresses is needed and, in some iterations, integration with payment information and processing can reduce errors and increase efficiency for the customer shipping the package and the carrier alike.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for shipping management. The system includes a shipping database configured to receive shipping information from a user regarding a package. The system also includes an access point, the access point connected to the shipping database and configured to receive the shipping information from the shipping database. The access point is also configured to measure at least one attribute of the package and send the measured attribute to the shipping database to be added to the shipping information. The system also includes a package drop, the package drop configured to receive the shipping information from the database, accept a package from the user and store the package until pickup by a shipping provider.

One example embodiment includes a system for shipping management. The system includes a shipping database configured to receive shipping information from a user regarding a physical package and an access point. The access point connected to the shipping database and configured to receive the shipping information from the shipping database. The access point is also configured to measure at least one attribute of the physical package and configured to send the measured attribute to the shipping database to be added to the shipping information. The access point includes a scale, where the scale measures the weight of the physical package and a size sensor, the size sensor configured to measure at least one dimension of the physical package. The system also includes a package drop. The package drop configured to receive the shipping information from the database, accept the physical package from the user and store the physical package until pickup by a shipping provider. The system additionally includes a communication module. The communication module configured to electronically communicate with a user's electronic system, where the communication module retrieves information from the user's electronic system and place the information from the user's electronic system in the shipping database.

Another example embodiment includes a system for shipping management. The system includes a shipping database configured to receive shipping information from a user regarding a physical package and a user interface. The user interface including at least a website and connected to the shipping database. The user interface configured to receive at least part of the shipping information from the user regarding the physical package and configured to send the shipping information to the shipping database. The system also includes an access point. The access point connected to the shipping database and configured to receive the shipping information from the shipping database. The access point is also configured to measure at least one attribute of the physical package and configured to send the measured attribute to the shipping database to be added to the shipping information. The access point includes a scale, where the scale measures the weight of the physical package and a size sensor, the size sensor configured to measure at least one dimension of the physical package. The system also includes a package drop. The package drop configured to receive the shipping information from the database, accept the physical package from the user and store the physical package until pickup by a shipping provider. The system additionally includes a communication module. The communication module configured to electronically communicate with a user's electronic system, where the communication module retrieves information from the user's electronic system and place the information from the user's electronic system in the shipping database. The communication module also configured to electronically communicate with the shipping provider and send the shipping information from the shipping database to the shipping provider.

Another example embodiment includes a system for shipping management. The system includes a shipping database configured to receive shipping information from a user regarding a physical package and a user interface. The user interface including at least a website and connected to the shipping database. The user interface configured to receive at least part of the shipping information from the user regarding the physical package and configured to send the shipping information to the shipping database. The system also includes an access point. The access point connected to the shipping database and configured to receive the shipping information from the shipping database. The access point is also configured to measure at least one attribute of the physical package and configured to send the measured attribute to the shipping database to be added to the shipping information. The access point includes a scale, where the scale measures the weight of the physical package and a size sensor, the size sensor configured to measure at least one dimension of the physical package. The system also includes a package drop. The package drop configured to receive the shipping information from the database. The package drop includes a collection box configured to receive the physical package and a secure storage configured to receive the physical package from the collection box and store the physical package until pickup by a shipping provider. The system additionally includes a communication module. The communication module configured to electronically communicate with a user's electronic system, where the communication module retrieves information from the user's electronic system and place the information from the user's electronic system in the shipping database. The communication module also configured to electronically communicate with the shipping provider and send the shipping information from the shipping database to the shipping provider.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of a system for retail shipping management;

FIG. 2 illustrates an example of an access point;

FIG. 3 illustrates an example of a user interface;

FIG. 4 illustrates an example of a package drop; and

FIG. 5 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

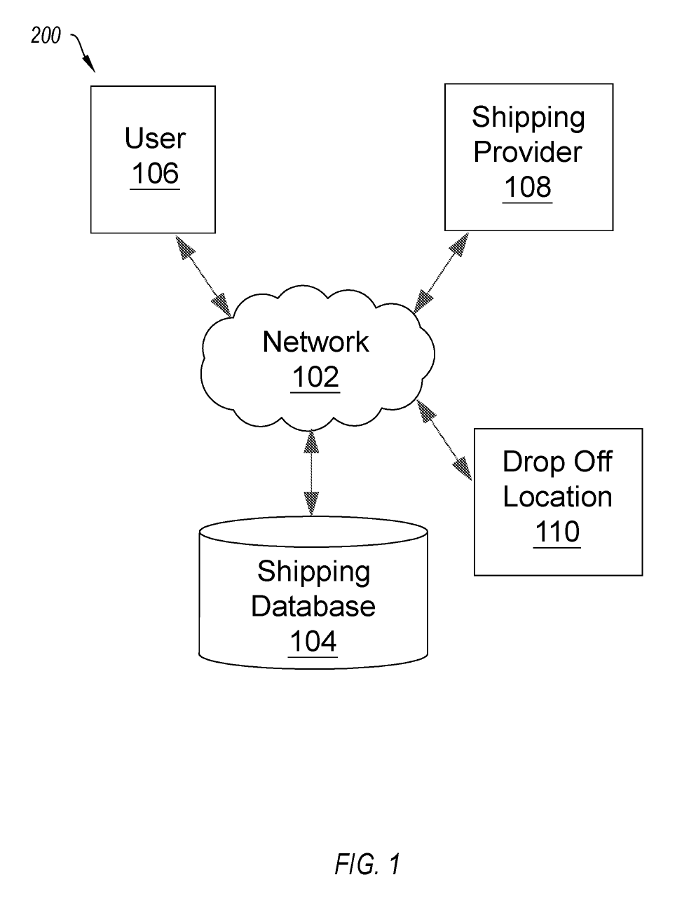

FIG. 1 is a block diagram illustrating an example of a system 100 for retail shipping management. In at least one implementation, the system 100 can be used to allow shipping customers speed up, facilitate and increase the accuracy of enrolling a package into a shipping system. The system 100 additionally increases usability and speed for a consumer. In particular, the system 100, as shown below, gives consumers relevant information quickly and passes information to where it is most needed by consumers to decrease time spent by the consumer in sending a package.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include shipping database 104. In at least one implementation, the shipping database 104 can include any system capable of storing and retrieving the desired data files. For example, the shipping database 104 can include an electronic database capable of electronically storing data. E.g., the shipping database 104 can include memory or memory banks. Additionally or alternatively, the shipping database 104 can include processors or other logic devices capable of executing software or carrying out other computer algorithms. The shipping database 104 can allow a user to access the hardware of the shipping database 104 for remote computing or for information retrieval.

FIG. 1 further shows that the system 100 can include a user 106. In at least one implementation, the user 106 can include any individual, business, organization or other entity which uses the system 100. For example, the user 106 can include a retail entity that ships products to consumers. Additionally or alternatively, the user 106 can include a company that ships to retail locations for sale to a consumer. The user 106 can access his/her user information in the shipping database 104 over the network 102. The user accesses the system 100 through one or more access points and/or user interfaces, as described below.

FIG. 1 additionally shows that the system 100 can include a shipping provider 108. The shipping provider 108 include any organization that provides a shipping service, such as UPS, FedEx, USPS, freight services or any other shipping company. In particular, the shipping provider 108 can receive a package at a designated location from a user 106 then deliver the package to a location specified by the user 106.

FIG. 1 moreover shows that the system 100 can include a drop off location 110. The drop off location 110 allows a user to deposit the package for actual shipment. I.e., the drop off location 110 is the site where the package transitions from user control to the custody of the shipping provider 110. For example, the drop off location 110 can include an access point or a package drop, as described below, or can be any other location where the shipping provider will receive the package (such as pickup at the user's location).

In at least one implementation, the user 106 records information about the package in the shipping database 104 over the network 102. The information can then be retrieved as needed by either the user 106 or the shipping provider 108 from the shipping database 104 over the network 102. The information can include any desired information; for example, the information can include time information, such as when the package was left with the shipping provider 108 or when the package is to be delivered, can include care information, such as what services were requested by the user 106 and/or performed by the shipping provider 108 or can include any other desired information. Additionally or alternatively, the information can include requests made by the user 106 such as, cost information, payment information (including but not limited to Credit Card, PayPal, Google Checkout, Close-Loop Valet Parking Account and Bill to Mobile Phone Carrier) or any other desired user request.

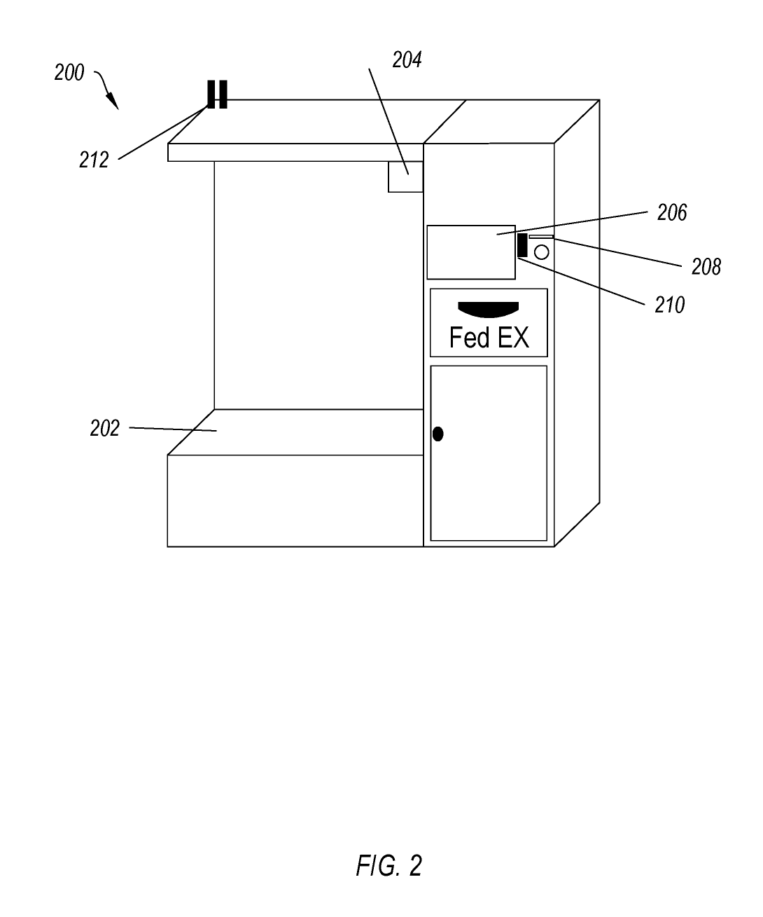

FIG. 2 illustrates an example of an access point 200. The exemplary access point 200 is a kiosk but other access points can include storefronts, mobile shipping units (such as trucks to pick up a package) or any other location where packages can be received for shipment. The access point 200 can allow a user to input desired shipping information, obtain costs and turn the package over to the shipping provider or can receive previously input information regarding the package and accept the package to be given to the shipping provider.

FIG. 2 shows that the access point 200 includes a scale 202. The scale 202 allows the weight of the package to be determined. For example, the scale 202 can include an input that allows a user to enter the weight or can include a device that measures and records the weight of the package. For example, the scale 202 can be configured to measure the weight of the package with an accuracy of approximately 0.01 pounds. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. As a result, the phrase “configured to” reaches well beyond merely describing functional language or intended use since the phrase actively recites an actual state of configuration. As used in the specification and the claims, the term approximately shall mean that the value is within 10% of the stated value, unless otherwise specified.

FIG. 2 also shows that the access point 200 can include a size sensor 204. The size sensor 204 allows the size or dimensions of the package to be determined. For example, the size sensor 204 can include an input that allows a user to enter the dimensions or can include a device that measures and records the size of the package. For example, the size sensor 204 can be configured to measure the dimensions of the package with an accuracy of approximately 0.1 inches.

FIG. 2 further shows that the access point 200 can include a user interface 206. The user interface 206 allows a user to enter desired information about the package such as contacts, account information, id information, ship to data, ship from data, payment methods, payment preferences, receipts, history, tracking data, coupons, special offers, social networking, sharing of information/offers or any other desired information. The user interface 206 can be touchscreen or can include a keyboard or other input device that allows a user to access or enter desired information.

FIG. 2 additionally shows that the access point 200 can include a label printer 208. The label printer 208 creates a label that includes information required by the carrier such as the destination address, tracking number and origination address. Additionally or alternatively, the label can include a code that can be scanned to obtain information electronically, such as a bar code or QR code. The label printer 208 can print a label that is placed on the package by a user or other individual or can print the label directly on the package, as desired.

FIG. 2 moreover shows that the access point 200 can include a payment input 210. The payment input 210 allows a user to pay for the package shipping. For example, the payment input 210 can include a credit card reader or NFC payment system. One of skill in the art will appreciate that the payment input 210 can be associated with or combined with the user interface 206. For example, the user interface 206 can allow a user to log in to his/her account and apply previously stored payment information or allow a user to pay via electronic payment systems such as PayPal.

FIG. 2 also shows that the access point 200 can include a communication module 212. The communication module 212 can allow a user to input information though an electronic handoff from a device such as a smartphone or via the internet. Additionally or alternatively, the communication module 212 can allow a shipping provider to retrieve shipping information from the access point for packages left at the access point. For example, the communication module 212 can send the shipping information via secure electronic communication or via electronic communication to an electronic device in proximity to the access point (e.g., integrated into a shipping truck).

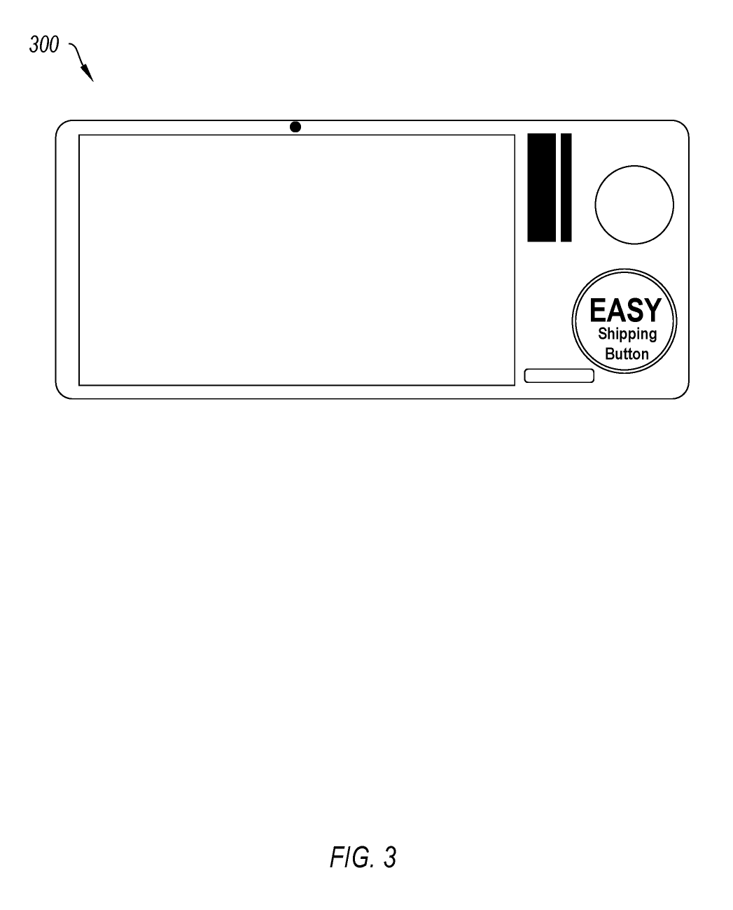

FIG. 3 illustrates an example of a user interface 300. The user interface is provided to the user at an access point, such as a webpage, at a kiosk, via a smart phone app or via any other desired medium. The user interface 300 can allow the user to enter or retrieve information necessary for the shipping of the package. For example, the user interface can allow a user to access his/her account to retrieve shipping information and/or payment information. The user interface 300 can include a graphical user interface, controls, speakers, displays or any other necessary hardware and/or software to adequately display the desired information to the user, as described below.

In at least one implementation, a graphical user interface (“GUI” sometimes pronounced gooey) is a type of user interface 300 that allows users to interact with electronic devices with images rather than text commands. GUIs can be used in computers, hand-held devices such as MP3 players, portable media players or gaming devices, cell phones, household appliances and office equipment. A GUI represents the information and actions available to a user through graphical icons and visual indicators such as secondary notation, as opposed to text-based interfaces, typed command labels or text navigation. The actions are usually performed through direct manipulation of the graphical elements.

By way of example, the user interface 300 can include a computer program, app, webpage, website, or some other means for conveying desired information to a user. For example, the user interface 300 can include a website that a user can log on to and view contacts, previous shipments, address where the package should be picked up, pick up date, delivery date, payment information, etc. For example, the user interface 300 can include an app for a smart phone that allows the user to retrieve and/or enter shipping information via a mobile device such as a cell phone, smart phone, tablet, laptop/computer or any other electronic device.

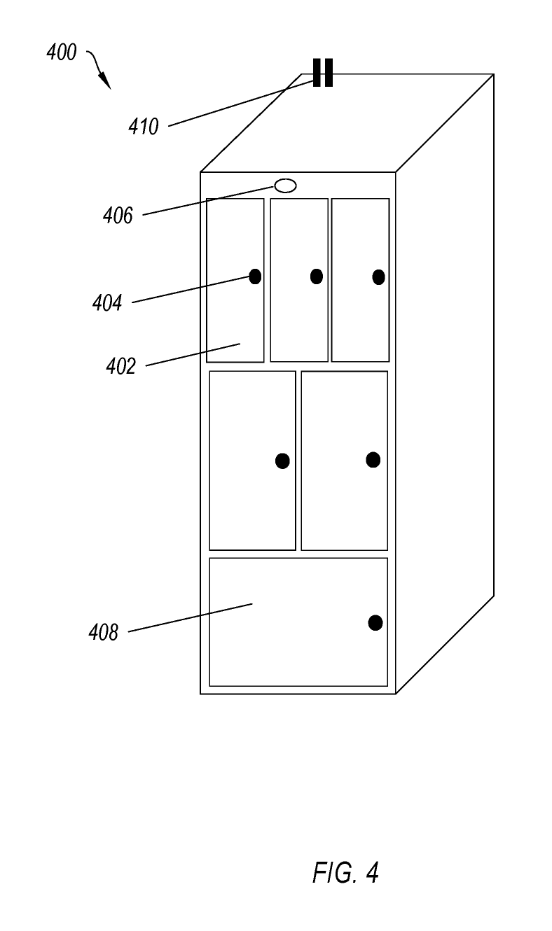

FIG. 4 illustrates an example of a package drop 400. The package drop 400 provides a secure location for the package after it is left by the recipient. The package drop 400 can be integrated with the user interface 300 of FIG. 3 and/or the access point 200 of FIG. 2 or can be a standalone device. For example, a business with high shipping volume may have a kiosk installed but may not need a secure packages drop 400 as the shipping carrier comes to the business to retrieve packages. One of skill in the art will appreciate that the user can enter all relevant information via the user interface 300 of FIG. 3, send the information to an access point 200 of FIG. 2 received via communication module 212 of FIG. 2, weigh and measure the package at the access point 200 of FIG. 2, receive a label from the label printer 208 and leave the package at the package drop 400.

FIG. 4 shows that the package drop 400 can include a collection box 402. The collection box 402 is configured to receive a package that meets size and weight requirements. That is, any package that is below the maximum size and weight of the collection box 402 can be left in the collection box 402. The package drop 400 can include standard sizes or oversized boxes as desired. One of skill in the art will appreciate that the package drop 400 can include multiple collection boxes 402 if so desired. For example, the package drop 400 can include a first collection box 402 for standard size packages, a second collection box 402 for oversized packages, a third collection box 402 for envelopes and a fourth collection box 402 for long packages.

FIG. 4 further shows that the package drop 400 can include an electronic lock 404. The electronic lock 404 secures the collection box 402 when not in use and allows the collection box 402 to be opened when a package is expected. That is, the electronic lock can receive a signal that a package is ready to be deposited and allow the collection box 402 to be accessed by the user.

FIG. 4 additionally shows that the package drop 400 can include an indicator 406. The indicator 406 alerts a user that the electronic lock 404 has disengaged and the collection box 402 can be opened to allow deposit of the package. For example, the indicator 406 can include an audio sound and/or a visual indicator. E.g., if the package drop 400 includes multiple collection boxes 402 the indicator 406 can include a visual indicator of in which collection box 402 the package should be deposited.

FIG. 4 also shows that the package drop 400 can include a secure storage 408. The secure storage 408 receives the package from the collection box 402 and is secured against unauthorized retrieval. For example, the secure storage 408 can be below the collection box 402 so that when the door to the collection box 402 is closed the package is gravity fed to the secure storage 408. The collection box can include a standard lock that allows the shipping provider to retrieve packages from the secure storage 408.

FIG. 4 moreover shows that the package drop 400 can include a communication module 410. The communication module 410 can receive signals from an access point that a package is to be dropped off at the package drop 400. Likewise, a signal can be sent via wireless communication, such as Bluetooth or NFC, that deposit is initiated (i.e., that all portions of the transaction including production of a shipping label have been completed) and that the package drop 400 should be authorized. In addition, the communication module 410 can send an indication that pickup by the carrier should be scheduled, either because packages are present or that pickup should be expedited if the space in the secure storage 408 is at or near capacity. Additionally or alternatively, the communication module 410 can indicate that service is needed because an error has been encountered.

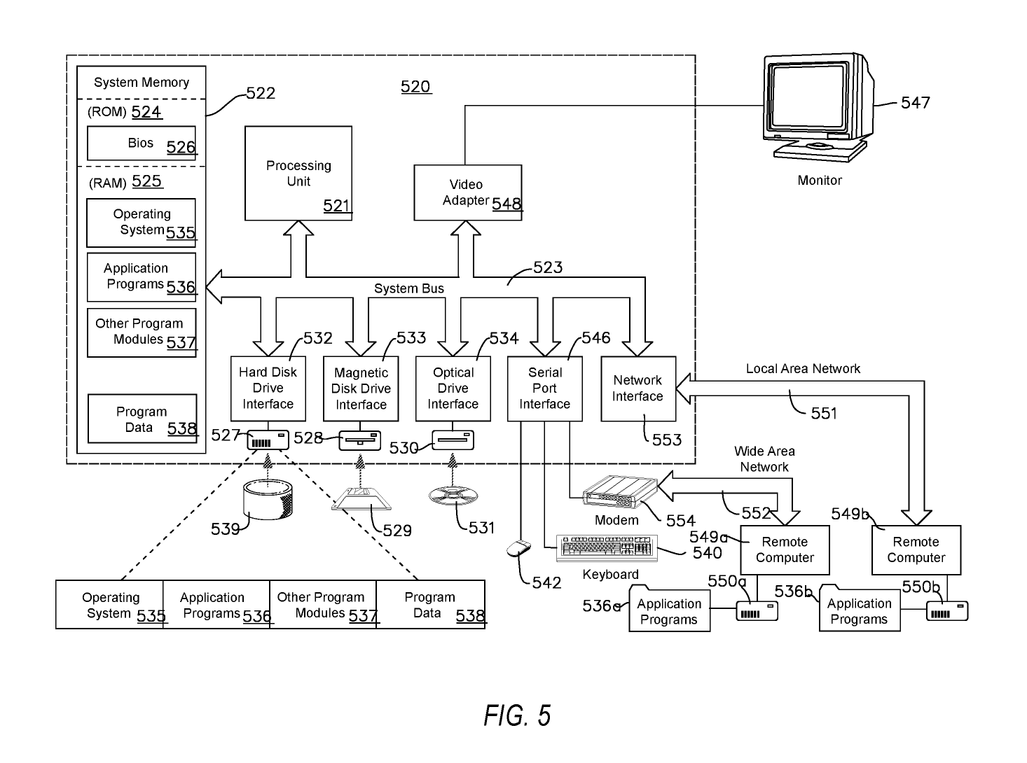

FIG. 5, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an example system for implementing the invention includes a general purpose computing device in the form of a conventional computer 520, including a processing unit 521, a system memory 522, and a system bus 523 that couples various system components including the system memory 522 to the processing unit 521. It should be noted however, that as mobile phones become more sophisticated, mobile phones are beginning to incorporate many of the components illustrated for conventional computer 520. Accordingly, with relatively minor adjustments, mostly with respect to input/output devices, the description of conventional computer 520 applies equally to mobile phones. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disk drive 528 for reading from or writing to a removable magnetic disk 529, and an optical disc drive 530 for reading from or writing to removable optical disc 531 such as a CD-ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, motion detectors or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 can be connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for shipping management, the system comprising:
a shipping database configured to receive shipping information from a user regarding a physical package;
an access point, the access point:
connected to the shipping database;
configured to receive the shipping information from the shipping database;
configured to measure at least one attribute of the physical package; and
configured to send the measured attribute to the shipping database to be added to the shipping information; and
including:
a scale, wherein the scale measures the weight of the physical package; and
a size sensor, the size sensor configured to measure at least one dimension of the physical package;
a package drop, the package drop configured to:
receive the shipping information from the database;
accept the physical package from the user; and
store the physical package until pickup by a shipping provider; and
a communication module, the communication module configured to:
electronically communicate with a user's electronic system, wherein the communication module retrieves information from the user's electronic system; and
place the information from the user's electronic system in the shipping database.

2. The system of claim 1, wherein the user's electronic system includes:
a user's email account.

3. The system of claim 1, wherein the user's electronic system includes:
a user's cell phone.

4. The system of claim 1, wherein the user's electronic system includes:
the user's shipping account.

5. The system of claim 1, wherein the information from the user's electronic system includes:
information pulled from an electronic contact.

6. The system of claim 1, wherein the information from the user's electronic system includes:
information regarding the user.

7. The system of claim 6, wherein the information regarding the user includes:
payment information.

8. The system of claim 6, wherein the information regarding the user includes:
the user's contact information.

9. The system of claim 1, wherein the access point is a kiosk.

10. The system of claim 1, wherein the access point includes a label printer.

11. The system of claim 10, further comprising:
printing a shipping label for the user to affix to the package.

12. The system of claim 11, wherein the shipping label includes a bar code.

13. The system of claim 11, wherein the shipping label includes a QR code.

14. The system of claim 1, wherein the access point includes a payment input.

15. The system of claim 14, wherein the payment input includes a credit card reader.

16. A system for shipping management, the system comprising:
a shipping database configured to receive shipping information from a user regarding a physical package;
a user interface, the user interface:
including at least a website;
connected to the shipping database;
configured to receive at least part of the shipping information from the user regarding the physical package; and
configured to send the shipping information to the shipping database;
an access point, the access point:
connected to the shipping database;
configured to receive the shipping information from the shipping database;
configured to measure at least one attribute of the physical package;
configured to send the measured attribute to the shipping database to be added to the shipping information;
including:
a scale, wherein the scale measures the weight of the physical package; and
a size sensor, the size sensor configured to measure at least one dimension of the physical package; and
configured to provide a shipping label to the user;
a package drop, the package drop configured to:
receive the shipping information from the database;
accept the physical package from the user; and
store the physical package until pickup by a shipping provider; and
a communication module, the communication module configured to:
electronically communicate with a user's electronic system, wherein the communication module retrieves information from the user's electronic system;
electronically communicate with the shipping provider;
place the information from the user's electronic system in the shipping database; and
send the shipping information from the shipping database to the shipping provider.

17. The system of claim 16, wherein the user interface sends the information to the shipping database via a NFC connection to the access point.

18. A system for shipping management, the system comprising:
a shipping database configured to receive shipping information from a user regarding a physical package;
a user interface, the user interface:
connected to the shipping database; and
configured to receive at least part of the shipping information from the user regarding the physical package; and
configured to send the shipping information to the shipping database;
an access point, the access point:
connected to the shipping database;
configured to receive the shipping information from the shipping database;
configured to measure at least one attribute of the physical package;
configured to send the measured attribute to the shipping database to be added to the shipping information;
including:
a scale, wherein the scale measures the weight of the physical package; and
a size sensor, the size sensor configured to measure at least one dimension of the physical package; and
configured to provide a shipping label to the user;
a package drop, the package drop:
configured to receive the shipping information from the database; and
including:
a collection box configured to receive the physical package; and
a secure storage configured to receive the physical package from the collection box and store the physical package until pickup by a shipping provider; and
a communication module, the communication module configured to:
electronically communicate with a user's electronic system, wherein the communication module retrieves information from the user's electronic system;
electronically communicate with the shipping provider;
place the information from the user's electronic system in the shipping database; and
send the shipping information from the shipping database to the shipping provider.

19. The system of claim 18, wherein the collection box includes an electronic lock, the electronic lock configured to:
secure the collection box when not in use; and
allows the collection box to be opened when a physical package is expected.

20. The system of claim 18, wherein the collection box includes an indicator to indicate to a user that the physical package may be deposited in the collection box.
